(19) United States
(12) Patent Application Publication
(10) Pub. No.: US 2012/0047574 A1
(43) Pub. Date: Feb. 23, 2012

(54) TERMINAL AND METHOD FOR RECOGNIZING MULTI USER INPUT

(75) Inventors: Changhun KIM, Gwangmyeong-si (KR); Donghyuk YANG, Seoul (KR)

(73) Assignee: PANTECH CO., LTD., Seoul (KR)

(21) Appl. No.: 13/196,816

(22) Filed: Aug. 2, 2011

(30) Foreign Application Priority Data
Aug. 23, 2010 (KR) 10-2010-0081675

(51) Int. Cl. G06F 7/04; G06F 21/00

(52) U.S. Cl. 726/18; 726/19

(57) ABSTRACT

A terminal includes an input unit to receive input signals of users, a human information detection unit to detect user human information of the users, a user identification unit to identify the users using the user human information, and a control unit to identify the users corresponding to the input signals, and to control the terminal according to the input signals of the identified users. A method for controlling a terminal includes receiving input signals of users, detecting user human information, identifying the user using the user human information, identifying the users corresponding to the received input signals, and controlling the terminal according to the input signals of the identified users.

### CROSS-REFERENCE TO RELATED APPLICATION

This application claims priority from and the benefit under 35 U.S.C. §119(a) of Korean Patent Application No. 10-2010-0081675, filed on Aug. 23, 2010, which is incorporated by reference for all purposes as if fully set forth herein.

### BACKGROUND

1. Field

This disclosure relates to a terminal and a method for recognizing the identity of a user according to the received user inputs.

2. Discussion of the Background

Recently, because of the rapid development in information communication technology and infrastructures thereof, users may obtain desired data using terminals, such as smart phones, laptop computers, personal digital assistants (PDAs) or kiosks anytime and anywhere. In the past, such terminals used a keypad method. However, recently, with the development of touchscreen technology, a touchscreen input method has become largely employed.

In particular, portable smart phones or kiosks installed in public places may use a full touchscreen method. Through a multi-touch function, users may use applications provided on terminals, such as games, more efficiently.

However, since such terminals may recognize only a single user input, it may be difficult to distinguish various users that may be providing user inputs and to perform control according to the individual users.

### SUMMARY

Exemplary embodiments of the present invention provide a terminal to recognize input signals of multiple users to control the terminal using per-user environment information and user relationship information, and a method of controlling the same.

Additional features of the invention will be set forth in the description which follows, and in part will be apparent from the description, or may be learned by practice of the invention.

Exemplary embodiments of the present invention provide a terminal including an input unit to receive input signals of users; a human information detection unit to detect user human information of the users; a user identification unit to identify the users using the user human information; and a control unit to identify the users corresponding to the input signals, and to control the terminal according to the input signals of the identified users.

Exemplary embodiments of the present invention provide a method for controlling a terminal, the method including receiving input signals of users; detecting user human information; identifying the user using the user human information; identifying the users corresponding to the received input signals; and controlling the terminal according to the input signals of the identified users.

Exemplary embodiments of the present invention provide a terminal including an input unit to receive a user input; a human information detection unit to detect a user human information; a user identification unit to identify the user using the user human information; and a control unit to identify the user corresponding to the user input, and to control the terminal according to the user input of the identified user.

It is to be understood that both foregoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram illustrating a terminal according to an exemplary embodiment of the invention.

FIG. 2 is a flowchart illustrating a method for controlling a terminal according to an exemplary embodiment of the invention.

FIG. 3a and FIG. 3b are diagrams illustrating a text input state in a user environment configuration of a terminal according to an exemplary embodiment of the invention.

FIG. 4 is a diagram illustrating an operation of a Whac-A-Mole® game on a terminal according to an exemplary embodiment of the invention.

FIG. 5 is a diagram illustrating a millstone rolling game of a terminal according to an exemplary embodiment of the invention.

### DETAILED DESCRIPTION OF THE ILLUSTRATED EMBODIMENTS

The invention is described more fully hereinafter with reference to the accompanying drawings, in which exemplary embodiments are shown. This invention may, however, be embodied in many different forms and should not be construed as limited to the exemplary embodiments set forth herein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be further understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g., XYZ, XZ, YZ).

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Throughout the drawings and the detailed description, unless otherwise described, the same drawing reference numerals are understood to refer to the same elements, features, and structures. The relative size and depiction of these elements may be exaggerated for clarity, illustration, and convenience.

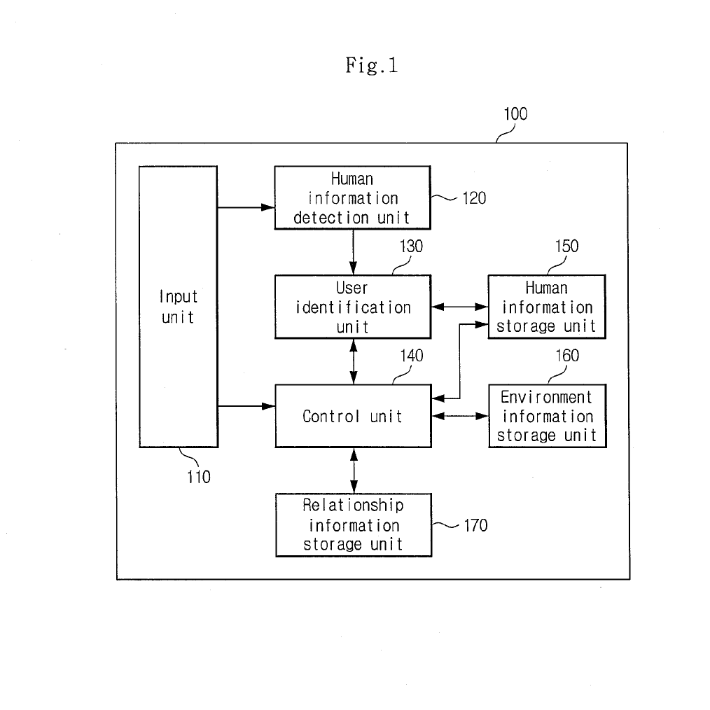

FIG. 1 is a schematic diagram illustrating a terminal according to an exemplary is embodiment of the invention.

As shown in FIG. 1, a terminal 100 includes an input unit 110, a human information detection unit 120, a user identification unit 130, a control unit 140, a human information storage unit 150, an environment information storage unit 160, and a relationship information storage unit 170.

The input unit 110 receives a user signal input to the terminal 100. For example, the input unit 110 may be one of a touchscreen, a keypad, a voice recognition device, an image recognition device, a combination thereof and the like mounted in the terminal 100. In addition, a touchscreen may recognize inputs of multiple users (“multi-touch”).

The human information detection unit 120 detects user human information. In an example, user human information may include body current information, biorhythm information, fingerprint information, body temperature information, voice information, image information and a combination thereof from the user input signal received by the input unit 110. Further, the voice information may be detected if the input unit 110 is or includes a voice recognition device, and the image information may be detected if the input unit 110 is or includes an image recognition device.

The body current information, the biorhythm information, the fingerprint information and the body temperature information may be detected if the input unit 110 is or includes a keypad or a touchscreen. If the input unit 110 is or includes a touchscreen, which supports a multi-touch function and multiple users touch several points of the touchscreen, the input unit 110 may receive the input signals. In addition, the human information detection unit 120 may detect the user body's current information, the biorhythm information, the fingerprint information, the body temperature information of the users and the like or other identifying information based on the input signals received by the input unit 110. The user human information, such as the body current information, the biorhythm information, the fingerprint information and the body temperature information, may be acquired from a change in electrical current or voltage, or based on a touch coordinate of the user input.

The user identification unit 130 identifies the user through the user human information detected by the human information detection unit 120. In an example, the user identification unit 130 may use user human information stored in the human information storage unit 150 to identify the user. That is, the user human information, such as the body current information, the biorhythm information and the fingerprint information, as well as other user human information, may be stored in the human information storage unit 150. The user identification unit 130 compares the user human information detected by the human information detection unit 120 with the user human information stored in the human information storage unit 150 to identify the user. The method of identifying the user according to various input units 110 will now be described in detail.

A user identification method using a current difference if a user touches a touchscreen is described here. In an example, user A and a user B may both touch the touchscreen of the terminal. Since the users may have different electric charges, it may be possible to identify the users according to the current difference caused by a difference in electric charge. This may be possible even if the users simultaneously touch the touchscreen. Although aspects are not limited thereto, specific portions of the terminal 100 may be designated to receive a user input. Further, a user may grasp a portion of the terminal 100 with one hand and touch the touchscreen with the other hand so as to determine current difference for the user. In this case, multiple specific portions of the terminal 100 may send currents of specific intensities or specific signals allowing identification of the users. User human information set for each signal may be stored in the human information storage unit 150. The received user input signal information obtained by each user touching a portion of the touchscreen for sending the current may be compared with intensity of current or signal of each user received by a touch sensing unit, thereby identifying the user.

In an example, the user may also be identified using user voice information. That is, if the input unit 110 is or includes a voice recognition device, the user voice information may be received using the voice recognition device and frequency information of the user voice information may be compared with information stored in the human information storage unit 150 to identify the user.

In an example, the user may also be identified using image information of the user. That is, if the input unit 110 is or includes an image recognition device, image information of the user's face may be compared with information stored in the human information storage unit 150 to identify the user.

The control unit 140 identifies the user corresponding to the received input signal using the user human identification information determined by the user identification unit 130. In addition, the control unit 140 may control the terminal 100 to correspond to the input signal of the identified user. In an example, the control unit 140 may use per-user terminal control environment information stored in the environment information storage unit 160 and user relationship information stored in the relationship information storage unit 170 to control the terminal 100 according to the determined user identification information.

In an example, the per-user terminal control environment information may be stored in the environment information storage unit 160. The term “per-user terminal control is environment information” may refer to environment information of the terminal 100 set by each user. In addition, “per-user terminal control environment information” may also refer to a basic control environment information of the terminal 100, or specific application control environment information. For example, if the terminal 100 is a smart phone, the per-user terminal control environment information may include basic control environment information, such as a receiver tone volume level, presence/absence of touch vibration, font, a screen saver to be displayed on the display panel, or a variety of application control environment information that may be provided upon execution of a specific application.

User relationship information may be stored in the relationship information storage unit 170. The term “user relationship information” may refer to information indicating a relationship among the users identified by the user identification unit 130 based on the user input signals received by the input unit 100. Further, the “user relationship information” may be used as basic information for the control of the terminal 100, and may include categories of “independent relation information”, “cooperative relationship information” and “major-minor relationship information.”

The control unit 140 may control the terminal 100 using the per-user terminal control environment information stored in the environment information storage unit 160, and the user relationship information stored in the relationship information storage unit 170. That is, if the user corresponding to the received input signal is identified by the user identification unit 130, the control unit 140 may detect the terminal control environment information corresponding to the identified user from the environment information storage unit 160. Accordingly, the control unit 140 may control the terminal 100 with the identified attributes corresponding to the user identity. At this time, if input signals of multiple users are received, the user relationship information may be retrieved from the relationship information storage unit 170 to control the terminal 100 correspondingly thereto. Although shown in FIG. 1 as including human information storage unit 150, environment information storage unit 160, and relationship information storage unit 170, aspects may not be limited thereto such that human information storage unit 150, environment information storage unit 160, and relationship information storage unit 170 may be combined in and/or external to the terminal 100 and may be individual databases or may be combined as one or more databases.

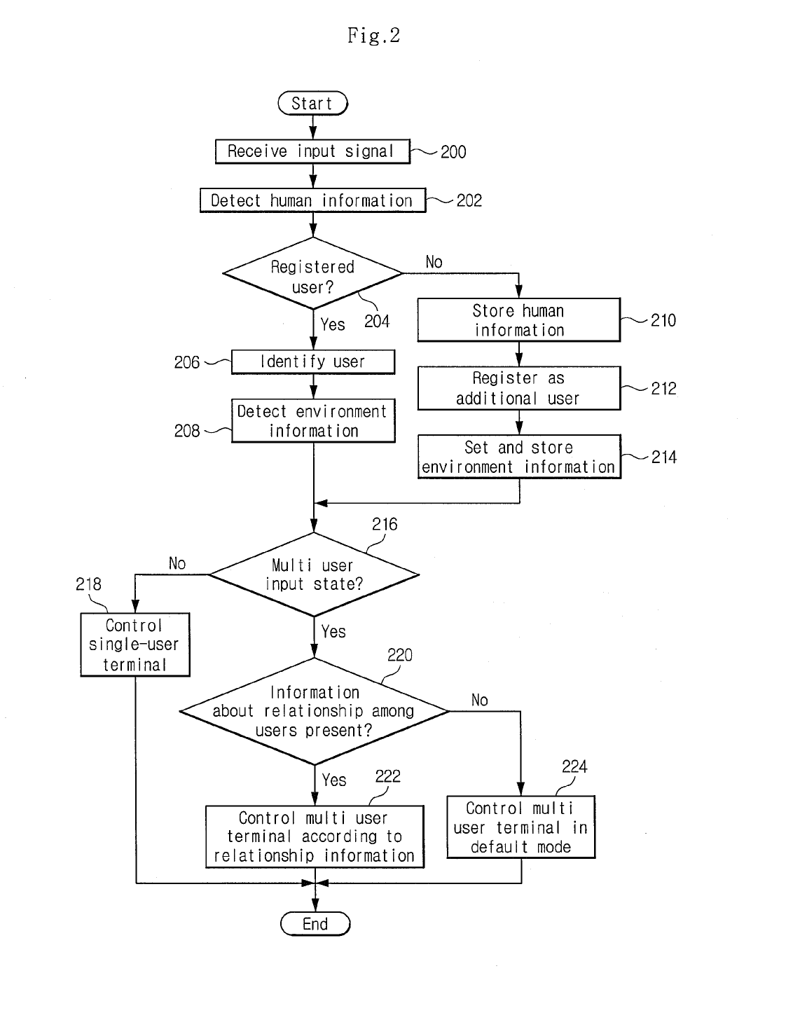

FIG. 2 is a flowchart illustrating a method for controlling a terminal according to an exemplary embodiment of the invention.

Referring to FIG. 2, the terminal 100 receives an input signal from a user through the input unit 110, where the terminal 100 operates with a basic control environment or a specific application (200). If the input signal of the user is received, the human information detection unit 120 detects the user human information based on the input signal (202). The user identification unit 130 then compares the detected user human information with the user human information stored in the human information storage unit 150, and determines whether the user of the input signal is registered (204).

If it is determined that the user of the input signal is registered, the user is identified using the user human information stored in the human information storage unit 150 (206). The identified user human information is transmitted to the control unit 140 and the control unit 140 detects the terminal control environment information of the identified user from the environment information storage unit 160 (208).

Alternatively, if it is determined that the user of the input signal is not registered, the detected user human information is stored in the human information storage unit 150 (210), and the user is registered as an additional user (212). At this time, the user may set and store his or her terminal environment information (214).

If the user is identified and the environment information is detected or stored as a new user environment information, the control unit 140 determines whether the terminal 100 is in a multi user input state (216). The control unit 140 determines whether inputs received by the terminal 100 are provided by a single user or multiple users based on the user human information identified by the user identification unit 130. For example, if the input unit 110 is a touchscreen, it may determine whether an input signal received is from a different user than the user of the previous input signal. Further, this determination may be conducted while the terminal 100 continuously or simultaneously receives user touch inputs.

If it is determined that the terminal 100 is not in the multi user input state, the control unit 140 controls the terminal 100 in a single user mode (218). At this time, the control unit controls the terminal 100 in the single user mode and controls the terminal 100 to configure the terminal control environment information according to the identity of the user. If the terminal control environment information of the user is not present, the terminal 100 may be controlled in a default mode.

If it is determined that the terminal 100 is in the multi user input state, the control unit 140 determines whether relationship information is available for the identified users based on the relationship information stored in the relationship information storage unit 170 (220). If it is determined that there is relationship information among the identified users, the control unit 140 controls the terminal 100 according to the relationship information (222). In contrast, if it is determined that relationship information is unavailable for the identified users, the control unit 140 controls the terminal 100 according to the default mode (224).

That is, if it is determined that the terminal 100 is in the multi user input state, the control unit 140 controls the terminal 100 according to the received user input signals and relationship information of the users. The control of the terminal 100 according to the relationship information of the users will now be described in detail.

The relationship information of the users may be set according to the operation state of the terminal 100, such as execution of a specific application. In an example, the relationship information of the users may be classified into three relationships, “independent relationship information,” “cooperative relationship information,” and “major-minor relationship information.” The disclosed relationships are not limited to the three enumerated relationships and are provided for simplicity in explanation.

The “independent relationship information” indicates that, if input signals of multiple users are received, the terminal 100 is controlled according to the received input signal of a specific user independent of input signals of the other users. In this case, the terminal 100 may be controlled according to the terminal control environment information of the specific user.

For example, if the terminal 100 has two earphone terminals, only the volume of one of the user's the earphone connected to the terminal may be controlled in response to that user's volume control. And, if the terminal 100 is an apparatus for displaying navigation information for a driver and displaying a TV program for a passenger according to viewing angles, in response to the same input, a navigation map may be enlarged or reduced if the driver operates the apparatus, and a channel may be changed if the passenger operates the apparatus. Similarly, if the terminal 100 provides a split screen interface, desired screens may be controlled according to users. If the terminal 100 has a mouse as the input unit 110, setting associated with a left-hander or a right-hander, a mouse pointer movement speed or a mouse icon may be changed according to users. Users may compete in a game application operation mode, such as a “picture puzzle” game, a sports game, or a martial arts game.

The information about the relationship among the users may also be “cooperative relationship information”. That is, users may cooperate with each other in the “picture puzzle” game, but the respective statistical scores of the users may be displayed after the game ends. If an item is acquired during a game, different items may be displayed according to the class of the users if the item is selected by a user. If attacking a boss in a game, if different users simultaneously attack the weak point of the boss in a reference range, damage may be increased.

Users may take the same action or a specified action simultaneously or at appropriate timings. For example, in a rhythm game, music may be played if users take a specified action. Also, a picture may be drawn such that colors and lines are changed according to the input points and pressure of a touch user input.

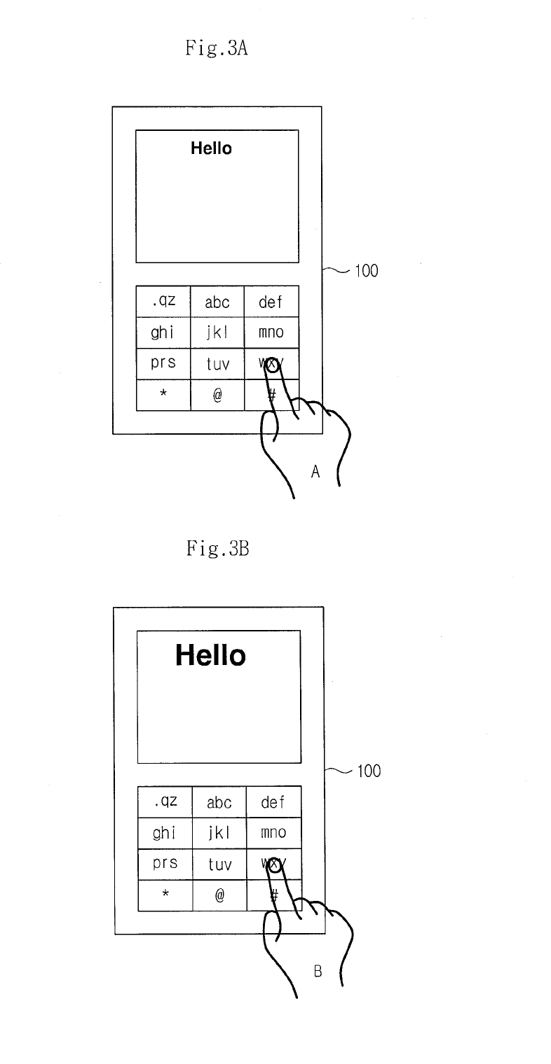

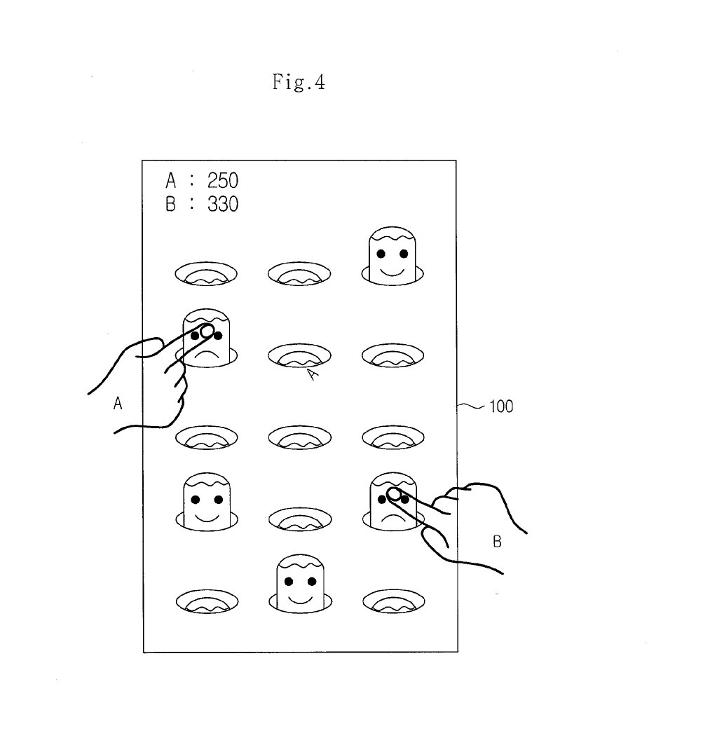

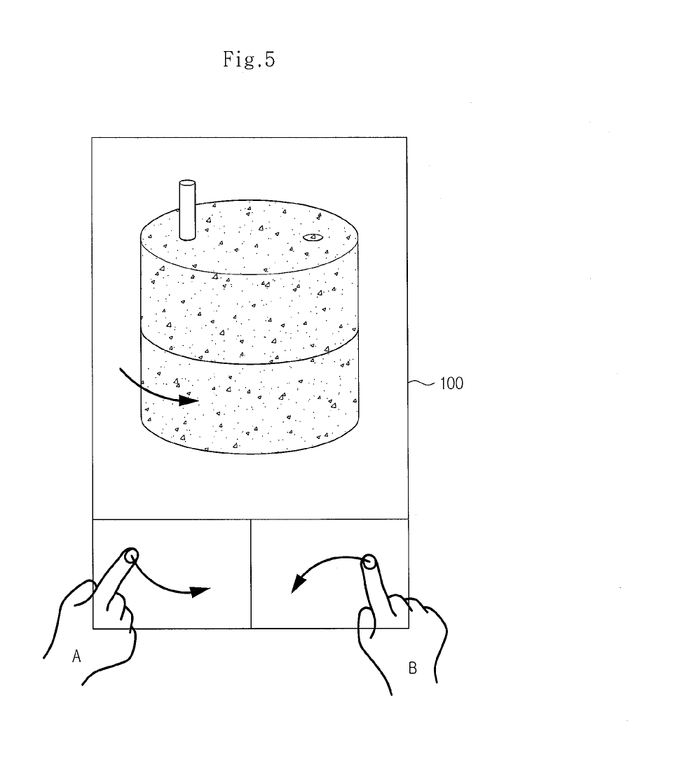

The information about the relationship among the users may also be “major-minor relationship information”. That is, if the number of users of the terminal 100 is two or more, an input signal of a specific user may be processed preferentially in a specific operation mode. In an example, only the input signal of a specific user, “major user”, may be valid if an application associated with personal privacy or security is executed. Further, an input signal of the major user may be processed preferentially over the other users if multiple user input signals are received while an application, such as a quiz game, is executed. Hereinafter, the operation of the terminal 100 according to an exemplary embodiment will be described in detail with reference to FIG. 3a, FIG. 3b, FIG. 4, and FIG. 5.

FIG. 3a and FIG. 3b are diagrams illustrating a text input state configured according to a user environment configuration of a terminal according to an exemplary embodiment of the invention.

In detail, FIG. 3a and FIG. 3b show the text input states of users where the terminal 100 is a smart phone. In the terminal 100, terminal control environment information associated with the text inputs of a user A and a user B may be stored. If the user A operates the terminal 100 in a text input mode and performs a touch input, the control unit 140 may determine that the user corresponding to the received touch input is the user A by using the user human information, such as the body current information.

If it is determined that the user of the touch input is the user A, the control unit 140 may retrieve the terminal control environment information of user A from the environment information storage unit 160. Referring to FIG. 3a, the control unit 140 detects a text size of 10 and a font “Gothic” as the terminal control environment information of the user A in the text input mode. Thus, text “hello” having a text size of 10 and a font “Gothic” is displayed on a screen according to the touch of the user A.

Similarly, referring to FIG. 3b, the control unit 140 determines that the user of the touch input is the user B, and detects a text size of “15” and a font “Gungsuh” as the terminal control environment information of the user B. Thus, text “hello” having a text size of 15 and a font of “Gungsuh” is displayed on a screen according to the touch of the user B.

With regard to FIG. 3a and FIG. 3b, the control of the terminal 100 in the text input mode may be executed in both a single user mode and a multi user mode. That is, the control unit 140 may determine whether the terminal 100 is in the multi user mode, for example, by continuously determining whether a new user input is received or by determining whether multiple user inputs are received within a reference time interval. These various methods may be applied differently, depending on whether the terminal 100 operates in the basic control environmental mode or executes a specific application.

That is, in FIG. 3a and FIG. 3b, if the input signal of the user B is received while the input signal of the user A is received (so as to input text according to the terminal control environment information of the user A), the text input may be immediately performed according to the terminal control environment information of the user B. Further, the text may be inputted according to the terminal control environment information of the user B if the input signal of the user B is received for a reference period of time or more. Even if the input signal of the user B is received while the text input of the user A is performed, the text input may be performed consistently according to the terminal control environment information of the user A.

Such a control of the terminal 100 according to the per-user terminal control environment information may be configured variously according to an application being executed in the terminal 100. In an example, if the input signals of the user A and the user B are received, the terminal 100 may be controlled according to the terminal control environment information of the user A or the user B if the relationship information between the user A and the user B is “independent relationship information”. If the information about the relationship between the user A and the user B is “cooperative relationship information” or “major-minor relationship information”, a restriction may be applied if the signal of the user B is received while the signal of the user A is received.

FIG. 4 is a diagram illustrating an operation of a Whac-A-Mole® game on a terminal 100 according to an exemplary embodiment of the invention.

FIG. 4 shows the case where the terminal 100 is a smart phone and, more particularly, a smart phone supporting multi-touch, where user A and user B are engaged in a Whac-A-Mole® game. Although aspects are not limited thereto, the illustrated example may be provided with the “independent relationship information” or the “cooperative relationship information” among the information about the relationship may also be applied to the Whac-A-Mole Game®. FIG. 4 illustrates the “independent relationship information” for simplicity of disclosure.

In the case where the game is executed by user A and user B having a relationship information classified as the “independent relationship information”, if the user A and the user B individually touch moles, the respective scores of the user A and the user B are individually counted so as to determine the winner of the game. FIG. 4 shows the case where the terminal 100 operates in the “independent relationship information” mode, the score of the user A is 250, and the score of the user B is 330.

Although not shown in FIG. 4, the Whac-A-Mole® game may be executed in the “cooperative relationship information” mode as well. In this case, the scores of the user A and the user B may be combined according to the touch inputs of the user A and the user B, and the total score will be displayed. However, even in this case, the respective scores of the users may be displayed in the final result so as to show the contribution of each user.

FIG. 5 is a diagram illustrating a millstone rolling game of a terminal according to an exemplary embodiment of the invention.

FIG. 5 shows the case where the terminal 100 is a smart phone supporting multi-touch and user A and user B are engaged in a millstone rolling game. Although aspects are not limited thereto, the illustrated example is provided with the “cooperative relationship information” applied to the millstone rolling game.

In an example, the millstone rolling game may be played by turning the millstone in a particular direction. The millstone game may be set so that the millstone may turn if the user A and the user B touch the lower end of the screen of the terminal 100 in the same direction. Alternatively, the millstone game may be set so that the millstone may turn if one of the user A and the user B touches the lower end of the screen. In the latter case, the millstone may turn faster if the other user touches the lower end of the screen in the same direction, and the millstone may turn more slowly if the other user touches the lower end of the screen in the opposite direction.

Although not shown in FIG. 4 and FIG. 5, multilateral relationship control among multiple users may be executed. In addition, multiple users may be divided into teams so that the terminal may be controlled according to the control environment information of the respective teams.

According to the terminal and the method of controlling the terminal according to exemplary embodiments, users may be identified using the user human information and the terminal may be controlled according to the terminal control environment information of the users. In addition, multiple users may be identified and the terminal may be controlled using relationship information corresponding to the users to provide an environment in which multiple users may use the terminal more conveniently and intuitively.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
an input unit to receive input signals of users;
a human information detection unit to detect user human information of the users;
a user identification unit to identify the users using the user human information; and
a control unit to identify the users corresponding to the input signals, and to control the terminal according to the input signals of the identified users.

2. The terminal of claim 1, wherein the input unit comprises at least one of a touchscreen, a keypad, a voice recognition device, and an image recognition device.

3. The terminal of claim 1, wherein the user human information comprises at least one of body current information, biorhythm information, fingerprint information, body temperature information, voice information, and image information.

4. The terminal of claim 1, further comprising a human information storage unit to store the user human information of the users,
wherein the user identification unit compares the detected user human information of the users with the stored user human information in the human information storage unit to find a match.

5. The terminal of claim 4, wherein the human information storage unit stores the detected user human information of one or more users, if no match is found to identify one or more users.

6. The terminal of claim 1, further comprising an environment information storage unit to store per-user terminal control environment information,
wherein the control unit retrieves the terminal control environment information corresponding to the one or more users from the environment information storage unit, and controls the terminal according to the terminal control environment information.

7. The terminal of claim 1, further comprising a relationship information storage unit to store relationship information of the users,
wherein the control unit retrieves the relationship information of the users from the relationship information storage unit, and controls the terminal to correspond to the input signals of the users according to the relationship information.

8. The terminal of claim 7, wherein, if the retrieved relationship information is an “independent relationship,” the control unit independently controls the terminal according to the input signal of each user.

9. The terminal of claim 7, wherein, if the retrieved relationship information is a “cooperative relationship,” the control unit controls the terminal according to the input signals of the users and combines the terminal control results.

10. The terminal of claim 7, wherein, if the retrieved relationship information is a “major-minor relationship,” the control unit designates one of the users as a “major” user and controls the terminal to preferentially process the input signal of the “major” user.

11. A method for controlling a terminal, comprising:
receiving input signals of users;
detecting user human information of the users;
identifying the user using the user human information;
identifying the users corresponding to the received input signals; and
controlling the terminal according to the input signals of the identified users.

12. The method of claim 11, wherein the input signals of the users are received through at least one of a touchscreen, a keypad, a voice recognition device, and an image recognition device.

13. The method of claim 11, wherein the user human information comprises at least one of body current information, biorhythm information, fingerprint information, body temperature information, voice information, and image information.

14. The method of claim 11, further comprising:
retrieving terminal control environment information of the identified users; and
controlling the terminal according to the terminal control environment information.

15. The method of claim 11, further comprising:
retrieving relationship information of the users; and
controlling the terminal to correspond to the input signals of the users according to the relationship information.

16. A terminal, comprising:
an input unit to receive a user input;
a human information detection unit to detect a user human information;
a user identification unit to identify the user using the user human information; and
a control unit to control the terminal according to the user input of the identified user.

17. The terminal of claim 16, wherein the user human information comprises at least one of body current information, biorhythm information, fingerprint information, body temperature information, voice information, and image information.

18. The terminal of claim 16, further comprising a human information storage unit to store the user human information of the user,
wherein the user identification unit compares the detected user human information of the user with the stored user human information in the human information storage unit to find a match.

19. The terminal of claim 18, wherein the human information storage unit stores the detected user human information of the user, if no match is found to identify the user.

20. The terminal of claim 16, further comprising an environment information storage unit to store per-user terminal control environment information,
wherein the control unit retrieves the terminal control environment information corresponding to the user from the environment information storage unit, and controls the terminal according to the terminal control environment information.
